(19) United States
(12) Patent Application Publication
(10) Pub. No.: US 2017/0307257 A1
(43) Pub. Date: Oct. 26, 2017

(54) ELECTRIC HEATING DEVICE

(71) Applicant: SIEMENS AKTIENGESELLSCHAFT, MUENCHEN (DE)

(72) Inventors: MICHAEL BRAUN, KOELN (DE); TURGAY CINARCI, ROESRATH (DE); RALPH GAERTNER, BRUEGGEN (DE); RAINER WIEGNER, SPENGE (DE)

(73) Assignee: SIEMENS AKTIENGESELLSCHAFT, MUENCHEN (DE)

(21) Appl. No.: 15/513,661

(22) PCT Filed: Sep. 16, 2015
(86) PCT No.: PCT/EP2015/071179

§ 371 Date: Mar. 23, 2017

(30) Foreign Application Priority Data
Sep. 23, 2014 (DE) 10 2014 219 142.4

(51) Int. Cl. F24H 9/20; H01H 37/04; F24H 3/04; A47K 10/48; F24H 9/18; F24H 9/02; H01H 37/36; H01H 37/00

(52) U.S. Cl. CPC F24H 9/2071; H01H 37/36; H01H 37/04; H01H 37/006; A47K 10/48; F24H 9/1863; F24H 9/02; F24H 3/0411; F24H 2250/02

(57) ABSTRACT

An electric heating device for emitting a heated air flow, in particular for a sanitary room or washroom in a rail-borne vehicle, includes an air duct, a fan generating the air flow, a heating element heating the air flow and a first over-temperature switch. The first over-temperature switch can reversibly switch off the heating element when a first over-temperature is exceeded. A second over-temperature switch can irreversibly switch off the heating element when a second over-temperature is exceeded. The second over-temperature switch is disposed in a recess, depression or opening formed in the air duct. The second over-temperature switch has a disconnect or isolating switch to be thermally triggered for switching off the heating element. The thermally triggered disconnect or isolating switch can be triggered by a glass sphere or bead that breaks when the second over-temperature is exceeded.

The present invention relates to an electric heating device for emitting a heated air current, in particular for heating a sanitary room in a rail-borne vehicle.

### PRIOR ART

Known heating devices of this type already frequently comprise in addition to a thermostat for controlling the temperature of the discharged air current one to two safety stages for protecting the heating device from overheating. The first heating stage is generally achieved by means of a reversible over-temperature switch that a relay interrupts the current supply to a heating element within the heating device after a specified over-temperature is achieved. After the reversible over-temperature switch that is embodied mostly by way of a cold conductor or a bi-metal has cooled, the heating element is re-activated.

In a second safety stage, after a specific second over-temperature is achieved a non-reversible over-temperature switch that does not automatically reset disconnects the current supply to the heating element by way of a second relay. In the event that the relay that is controlled in this case fails by way of example as a result of aging processes, contact arcing or—in particular in a sanitary room—as a result of corrosion, the heating device can overheat and possibly catch fire.

### OBJECT OF THE INVENTION

The object of the invention is to provide an electric heating device that comprises a high degree of operational safety and that renders it possible to safely and reliably disconnect the heating element from the current supply.

The object is achieved by virtue of the features of the independent claims. Advantageous embodiments are disclosed in the subordinate claims.

s In accordance with the invention, an electric heating device is provided for emitting a heated air current, in particular for heating a sanitary room in a rail-borne vehicle, having an air duct and also a fan for generating the air current, and having a heating element for heating the air current and a first over-temperature switch, wherein the fan and the heating element are arranged in the air duct, and wherein the first over-temperature switch is embodied so as in the case of a first over-temperature being exceeded to switch off the heating element in a reversible manner, further comprising a second over-temperature switch that is embodied so as in the case of a second over-temperature being exceeded to switch off the heating element in a non-reversible manner, and wherein a recess is formed in the air duct, the second over-temperature switch is arranged in the recess, and the second over-temperature switch comprises a thermally-triggered isolating switch for switching off the heating element, wherein the thermally-triggered isolating switch can be triggered by means of a glass sphere that bursts in the case of the second over-temperature being exceeded.

In accordance with the prior art, the heating element is switched on or off frequently by way of an electric contactor or a relay. A first advantage of the heating device in accordance with the invention resides in the fact that the current supply to the heating element is not interrupted by way of a relay that is controlled by a second over-temperature switch but rather said current supply is interrupted by way of the second over-temperature switch itself. This means that a relay that is known from the prior art is omitted. The second over-current switch is thus embodied in an integral manner. Further advantages are achieved as a result of this integration.

Consequently, the electric connection between a second over-temperature switch and the relay is omitted. Furthermore the coil drive of the relay is omitted. By omitting these components, corresponding malfunction sources are omitted since the isolating switch is not triggered in an electric manner but rather can be triggered in a thermal manner.

The air duct of the heating device in accordance with the invention comprises a recess in which the second over-temperature switch is arranged. The recess is advantageously embodied with the second over-temperature switch in such a manner that the over-temperature switch is essentially arranged adjacent to the air current. In other words, the second over-temperature switch is arranged in a recess of the air duct in such a manner that the air current can essentially flow from the second over-temperature switch in an unhindered manner past said second over-temperature switch. The second over-temperature switch is advantageously arranged in a recess of the air duct in such a manner that the flow resistance formed by the second over-temperature switch is negligibly small. This feature provides the advantage that the second over-temperature switch exerts hardly any eddying effect on the air current.

This renders it possible in the case of an identical fan capacity to achieve a comparatively high air throughflow and also to achieve low operating noises caused by the air current.

The procedure of triggering the second over-temperature switch as a result of a glass sphere bursting as an actuator provides the advantage that owing to the brittle characteristic of glass the shape of the actuator does not change gradually but rather an abrupt change occurs. A gradual increase in temperature leads to a non-reversible and abrupt change in the form of the glass sphere in the case of the second over-temperature being exceeded so that the isolating switch can be triggered abruptly. The risk of sticky contacts or arcing can be reduced in this manner.

In an advantageous manner, the electric heating device is embodied in such a manner that the isolating switch comprises a switch and a switching mechanism having a switching element that is prestressed by means of a spring, wherein the switching mechanism is embodied so as when it is triggered it opens the switch in a non-reversible manner by way of the switching element.

Features of this type that render it possible to open an isolating switch in a safe and reliable manner are of advantage in an electric heating device that is also to be operated in a sanitary area. An electric heating device in which a switching mechanism that is prestressed by a spring can trigger the opening of a switch provides the advantage that in the case of the over-temperature switch being triggered the energy that is stored in the prestressed spring is made available for applying a force with which it is possible to implement or support the separation of the contacts of the switch. This consequently provides an advantage particularly in application cases in which owing to the increased corrosive conditions but also owing to aging processes or contacts arcing can lead to current-carrying contacts “sticking” or “baking” together. The switch is preferably embodied as an opening device. In principle, however, it is also possible to use a toggle switch wherein the switchover function is not used. The switching element is preferably embodied as a bridge. A design of this type overs the advantage that it can be implemented in a structurally simple manner. This can be achieved by way of example in such a manner that the switching element in the form of a conducting bridge connects the switch contacts of a switch. In so doing, the glass sphere prevents the switching element that is prestressed by means of a resilient force from leaving the position in which the switch contacts of the switch are connected. In the case of the glass sphere bursting, the spring travel path of the prestressed spring is revealed so that the resilient force causes the isolating switch to open.

In an advantageous manner, the electric heating device is embodied in such a manner that the glass sphere holds a fluid that can expand under the influence of heat, wherein the glass sphere can burst in the case of the second over-temperature being exceeded, and wherein as a result of the glass sphere bursting it is possible to trigger the switching element that is prestressed by the spring. This embodiment provides the advantage that so as to prestress the switching mechanism the undamaged glass sphere can absorb a resilient force that is large in relation to the dimensions of the over-temperature switch but which in the event of the glass sphere bursting is released abruptly so as to open the switch contacts. This renders it possible to reliably actuate the switch.

In an advantageous manner, the electric heating device is embodied in such a manner that the thermally-triggered isolating switch is arranged directly in a current path for supplying current to the heating element. An arrangement of this type provides a high degree of operational safety, since in comparison to an indirect interruption, in the case of a direct interruption of the current path the current path is not provided with an inter-positioned switching means that would need to be actuated.

In an advantageous manner, the electric heating device is embodied in such a manner that the air duct comprises an opening for the purpose of forming a recess that is covered by a hat-shaped heat shield. In particular, an opening that is small in relation to the cross-section of the air duct has only small negative influences on the air current. Furthermore, a hat-shaped heat shield renders it possible to accommodate the second over-temperature switch and to close the air duct to prevent the air current from escaping out of the air duct.

In an advantageous manner, the electric heating device is embodied in such a manner that the air duct is embodied from sheet metal and/or the hat-shaped heat shield is embodied by a sheet metal cover. A sheet metal cover that is embodied by way of example as a press-bent part is heat resistant and simultaneously can be produced in a simple and cost-effective manner.

In an advantageous manner, the electric heating device is embodied in such a manner that the air current in the air duct flows in a flow direction that can be predetermined by the fan and the recess is arranged in the flow direction upstream of the heating element. The second over-temperature switch is therefore triggered essentially as a result of the radiant heat being emitted by the heating element. A malfunction of this type can occur by way of example in the event of a failure of the fan or in the event of a blockage occurring in the air duct, in particular at the inlet or outlet of said air duct, as a result of luggage, contamination or rubbish being left near said air duct.

In an advantageous manner, the sensor of the first over-temperature switch is arranged at the same height of the heating element or to the rear of said heating element. An arrangement of this type means that the first over-temperature switch is arranged in the direct proximity of the heating element so that it is most likely that the temperature that is to be measured at the site of the sensor of the first over-temperature switch is higher than at the site of the second over-temperature switch. As a consequence, even in the case of uniform predetermined over-temperatures for the two over-temperature switches, the first reversible switching over-temperature switch would be triggered in each case prior to the second non-reversible switching over-temperature switch.

In an advantageous manner, the electric heating device is embodied in such a manner that the sensor of the first over-temperature switch is arranged upstream of the heating element and with regard to an installation direction that is provided by way of example in a rail-borne vehicle centrally above said heating element. In the event of a failure of the air flow, the highest temperature prevails at this site as a result of the thermal convection and as a consequence it is possible to achieve a rapid triggering of the first over-temperature switch.

In a further advantageous manner, the electric heating device is embodied in such a manner that the air duct comprises an inlet and an outlet and a thermostat sensor for controlling the heating element is arranged centrally in the air flow upstream of the outlet. In a further advantageous manner, the thermostat sensor is arranged closer to the outlet than to the heating element. By virtue of positioning the thermostat sensor in this manner, only a comparatively small disruption occurs in the homogeneity of the air flow and simultaneously it is rendered possible to ascertain a representative value for the temperature of the air flow being emitted by the heating device.

In an advantageous manner, the thermostat sensor and also the sensor of the first over-temperature switch are advantageously embodied with a round, oval, droplet-shaped or planar cross-section since in the case of an embodiment of this type such cross-sectional shapes form only a small flow resistance in the air duct.

Moreover, the electric heating device is advantageously embodied in such a manner that the air duct comprises sheet metal guides to guide the air flow. It is possible by appropriately arranging the sheet metal guides to avoid or at least reduce disruptions in the homogeneity of the air flow if the air duct has a change of direction, narrow places or disruptive elements, by way of example in the form of sensors.

In an advantageous manner, the air duct is optimized by means of the sheet metal guides in such a manner that its flow resistance is minimized. Furthermore, the electric heating device is advantageously embodied in such a manner that the air duct is optimized by means of the sheet metal guides in such a manner that the noise development is minimized.

In an advantageous manner, the electric heating device is embodied in such a manner that the fan is arranged between the inlet and the heating element, wherein the fan is arranged within the air duct in such a manner that the distance between the fan and the heating element is sufficiently small so that a homogenous air flow can flow through said aid duct and the distance is sufficiently large in order to prevent the fan being damaged by radiant heat in the case of temperatures below the second over-temperature. An arrangement of this type renders it possible to produce the heating device in a safe and reliable and simultaneously compact and short construction.

In an advantageous manner, the electric heating device is is moreover embodied in such a manner that the cross-section of the air duct is tapered from the inlet so as to optimize the achievable air flow volume and widens towards the outlet. An embodiment of this type renders it possible to discharge the air flow into the environment outside the heating device in a comparatively homogenous manner in which the eddy effect is low and consequently the noise level is also low. This applies in an identical manner for receiving the air flow.

In an advantageous manner, the electric heating device is moreover embodied in such a manner that the electric heating device comprises a signal/fault line in the form of a loop circuit which is connected in such a manner that it is interrupted synchronously so as to switch off the heating element by means of the first and/or the second over-temperature switch. It is possible by means of a signal/fault line of this type to signal a fault in the heating device to a remote maintenance unit. In an advantageous manner, the second over-temperature switch comprises a further switch that can be triggered by means of the switching mechanism using the switch for switching off the heating element jointly and said further switch is connected in such a manner that the signal/fault line can be interrupted by means of said further switch. In an identical manner, the first over-temperature switch also comprises two coupled switches, of which one switch is arranged so as to switch off the heating element and one switch is arranged so as to interrupt the signal/fault is line.

In an advantageous manner, the switch for interrupting the signal/fault line of the first over-temperature switch and a possible switch for interrupting the signal/fault line of the second over-temperature switch are connected in series since in this manner a malfunction can be signaled in an efficient manner.

In an advantageous manner, the electric heating device comprises a two-part housing having two independent housing units, wherein the air duct is arranged in a first housing unit and switching-on elements are arranged in a second housing unit and wherein the opening is formed between the first housing unit and the second housing unit and the hat-shaped heat shield is arranged in the second housing unit. In so doing. the term ‘switching-on elements’ includes the electric components for controlling the fan and the heating element, in other words the thermostat and the over-temperature switches. An embodiment of this type provides the advantage that different climatic conditions are possible in the two housing units. Whereas a very warm and consequently humid and also dusty climate is to be expected in the air duct, the electrics/electronics of the switching-on elements require a climate that has a low level of humidity and dust. By virtue of the independent arrangement, in other words the independently closed housing units, it is possible to separate the climatic conditions in a simple manner. By virtue of forming the recess, in other words the opening with the sheet metal cover lying on top of said recess, to the side of the second housing unit, the advantage is achieved that in this manner a recess is formed in the inside of the heating device and the outer shape of the heating device is not changed by the recess. In other words, such an arrangement of the recess renders it possible to arrange the second over-temperature switch in the second housing unit that is provided for the switching-on elements.

Moreover, the housing units are advantageously embodied in the form of two non-flammable troughs that are arranged one above the other. Apart from the feedthrough for supply lines, sensors, fan and heating element, said troughs are separate from one another. An arrangement of this type provides a simple facility for assembling/dismantling the heating device.

In accordance with the invention, a fan heater is moreover provided for sanitary facilities in rail-borne vehicles and said heater fan comprises one of the previously described electric heating devices.

By virtue of the simple and robust but simultaneously operationally safe and efficient embodiment of the previously described electric heating device, said heating device is suitable for use in rail-borne vehicles. In an advantageous manner, the stringent requirements for fire protection according to DIN EN 45545-5 Fire Protection in Rail-borne Vehicles can be fulfilled by means of the corresponding embodiment of the described heating device.

### EXAMPLES AND DRAWINGS

The invention is further explained hereinunder with the aid of preferred exemplary embodiments with reference to the attached drawings.

In the drawings:

FIG. 1 illustrates a rear view of an electric heating device in accordance with a first preferred embodiment of the invention, and

FIG. 2 illustrates a functional switching circuit of the exemplary embodiment shown in FIG. 1.

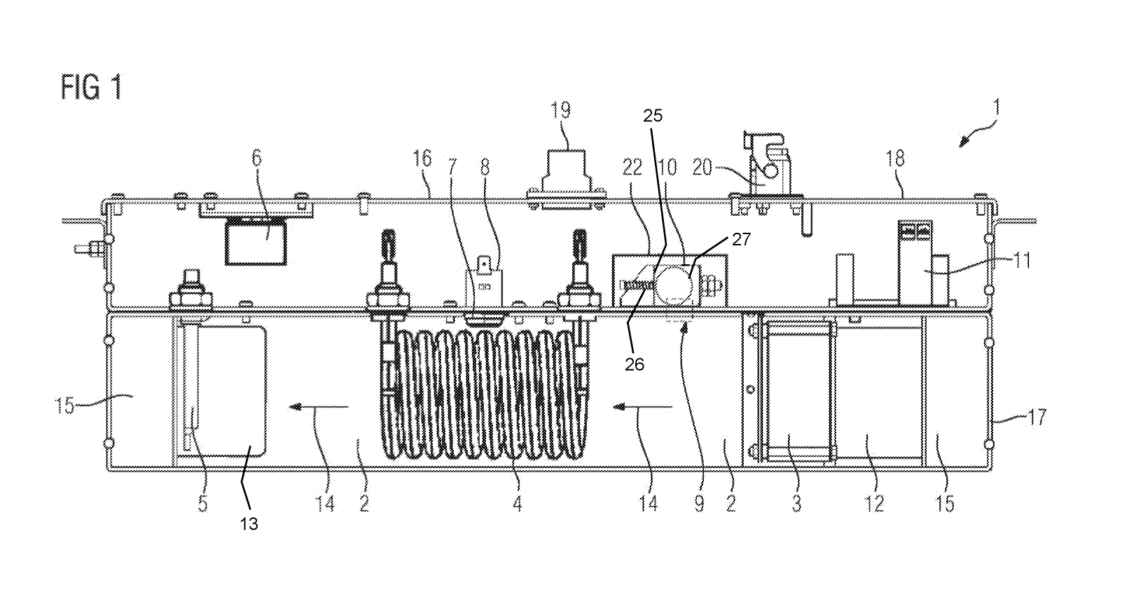

FIG. 1 illustrates an electric heating device 1 for rail-born vehicles in accordance with a first preferred embodiment of the invention. The figure illustrates essentially a rear view of the heating device 1 and the rear wall of a housing 16 is not illustrated.

It is evident from FIG. 1 that the heating device 1 comprises a two-part housing 16 having a first and a second housing unit 17, 18 that are embodied independently from one another. The housing units 17, 18 are embodied in the form of two non-flammable troughs that are arranged one above the other.

As is evident in the detail shown in FIG. 1, an air duct 2 is formed in the first housing unit 17 that is arranged at the bottom in FIG. 1. Furthermore, the housing unit 17 comprises an inlet 12 that is arranged on the right-hand side in FIG. 1 and an outlet 13 that is arranged on the left-hand side.

The air duct 2 extends between the inlet 12 and the outlet 13. A fan 3 is arranged in the air duct 2 and said fan produces an air flow in a flow direction 14, in FIG. 1 from right to left, in other words from the inlet 12 illustrated on the right-hand side to the outlet 13 illustrated on the left-hand side. The inlet 12 and the outlet 13 are embodied on the front face of the heating device 1 so that in the case of the rearward illustration they are covered in part by in each case a sheet metal guide 15.

As is illustrated in FIG. 1, the housing 16 comprises moreover a connection 19 for a data plug and also a mains connection 20 as a current supply.

The heating device 1 comprises a thermostat sensor 5 and a heating element 4 and they are both arranged in the air duct 2. A thermostat 6 for controlling the temperature of an air flow that is flowing out of the outlet 13 is positioned in the second housing unit 18 that is arranged at the top in FIG. 1. For this purpose, the temperature in the air duct 2 is ascertained by the thermostat sensor 5, a signal is transmitted to the thermostat 6 and on this basis the thermostat 6 controls the heating element 4 as explained in detail hereinunder.

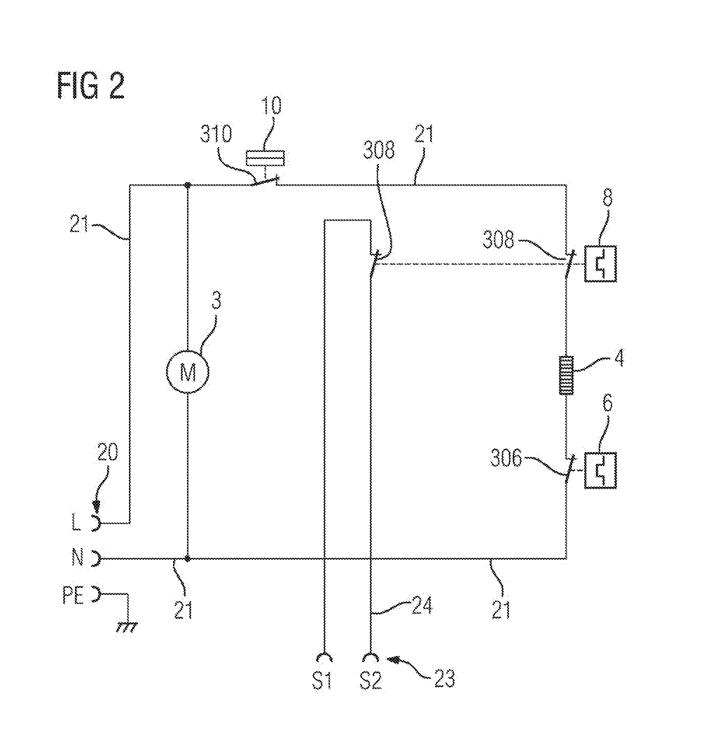

The heating device 1 comprises furthermore a first over-temperature switch 8 that is embodied so as to be reversible. The first over-temperature switch 8 comprises a sensor 7 that is arranged in the air duct 2 above the heating element 4. The sensor 7 is embodied as a temperature sensor. As illustrated in FIG. 2, the current path 21 connects the heating element 4 to the mains connection 20. The first over-temperature switch 8 is embodied so as to interrupt the current path 21 in the case of an over-temperature being ascertained using the sensor 7.

Furthermore, an opening device 306 of the thermostat 6 is arranged in the current path 21. If the temperature that is ascertained by the thermostat sensor 5 exceeds a predetermined upper desired temperature, the current path 21 and consequently the current supply to the heating element 4 are interrupted by way of the opening device 306. If the temperature that is ascertained by the thermostat sensor 5 is below a predetermined lower desired temperature, the current path 21 is connected by way of the opening device 306 and the current supply to the heating element 4 is possible.

Moreover, an opening device 308 of the first reversibly switching over-temperature switch 8 is arranged in the current path 21. If the temperature that is ascertained by the sensor 7 of the first over-temperature switch 8 exceeds a first over-temperature, the current path 21 and consequently the current supply to the heating element 4 is interrupted by way of the opening device 308. If the temperature that is ascertained by the sensor 7 of the first over-temperature switch 8 is below the first over-temperature, the current path 21 is reconnected by way of the opening device 308 and the current supply to the heating element 4 can be resumed.

The heating device 1 comprises furthermore a second over-temperature switch 10 that is embodied so as to be non-reversible. The second over-temperature switch 10 comprises an isolating switch that is not illustrated separately in the figures. The second over-temperature switch 10 is arranged in the air duct 2 in the flow direction 14 upstream of the heating element 4. Since the over-temperature switch 10 is arranged in the flow direction 14 upstream of the heating element 4, during a problem-free operation only cold air flows through said over-temperature switch. The over-temperature switch 10 heats up in the event of a build-up of heat, in other words as the volume flow that is usually flowing through the air duct 2 reduces. The cause of such a reduction in flow can be by way of example a malfunction of the fan 3 or foreign bodies that are present upstream of the inlet 12 or outlet 13 or in the air duct 2.

The second over-temperature switch 10 is thermally connected to the isolating switch so that a switching procedure is triggered directly as a result of a thermal influence on the over-temperature switch 10. For this purpose, the isolating switch comprises a non-reversible switching mechanism that is not illustrated separately in the figures and a switch that is embodied in this exemplary embodiment as an opening device 310.

In detail, the switching mechanism comprises a switching element, which is prestressed by a spring, and a glass sphere that holds a fluid that can expand by way of thermal expansion. The glass sphere can be destroyed as a result of thermal expansion of the expandable fluid in the case of the second over-temperature being exceeded. The switching element that is prestressed by means of the spring can be triggered as a result of the destruction of the glass sphere. In this embodiment, the switching element is embodied as a bridge so as to open the opening device 310.

As is evident from the switching circuit illustrated in FIG. 2 showing the function of the heating device 1 illustrated in FIG. 1, the opening device 310 is arranged in the current path 21 of the heating element 4 so that the opening device 310 of the second over-temperature switch 10 interrupts the current path 21 upon being actuated. Owing to the fact that the isolating switch is actuated in a non-reversible manner, the interruption in the current path 21 is likewise non-reversible. During a problem-free operating mode, the opening device 310 of the second over-temperature switch 10 is closed.

Furthermore, FIG. 2 illustrates a loop circuit 24 of a signal/fault line that can be connected by way of connection clamps 23 to a monitoring or maintenance device. The loop circuit 24 can be interrupted by an opening device 308 of the first over-temperature switch 8 and consequently signal a malfunction to a monitoring or maintenance device.

As is evident from FIG. 1, the housing units 17, 18 are essentially separate from one another. Switching-on elements of the heating device 1 are arranged in the second housing unit 18, in other words the thermostat 6, the first over-current switch 8, the second over-current switch 10 and the clamp holder 11. Feedthroughs for supply lines for the thermostat sensor 5, the sensor 7, the heating element 4 and the fan 3 are arranged between the housing units 17, 18 in order to connect them to the switching-on elements. Furthermore, the housing units 17, 18 comprise a common opening 9, wherein the opening 9 is covered on the side of the second housing unit 18 by a hat-shaped heat shield 22. The hat-shaped heat shield 22 limits the extent to which the air flow can spread through the opening 9.

The opening 9 is located in the flow direction 14 upstream of the heating element 4 so that the part of the air flow that passes through the opening 9 is not heated during the problem-free operation.

In the event of a malfunction which causes a backlog of warm air against the flow direction 14, warm air passes through the opening 9 into the volume formed by the hat-shaped heat shield 22. The second over-temperature switch 10 that is arranged at this site becomes warm as a result of the backlog of air and interrupts the current path 21 if the second over-temperature is exceeded.

1-10. (canceled)

11. An electric heating device for emitting a heated air current, the electric heating device comprising:
an air duct having a recess formed therein;
a fan disposed in said air duct for generating the air current;
a heating element disposed in said air duct for heating the air current;
a first over-temperature switch configured to reversibly switch off said heating element upon exceeding a first over-temperature; and
a second over-temperature switch disposed in said recess and configured to non-reversibly switch off said heating element upon exceeding a second over-temperature;
said second over-temperature switch including a thermally-triggered isolating switch for switching off said heating element, said thermally-triggered isolating switch having a glass sphere bursting upon exceeding the second over-temperature for triggering said thermally-triggered isolating switch.

12. The electric heating device according to claim 1, wherein the air current heats a sanitary room in a rail-borne vehicle.

13. The electric heating device according to claim 1, wherein said thermally-triggered isolating switch includes a switch and a switching mechanism having a switching element being prestressed by a spring, said switching element non-reversibly opening said switch upon triggering said switching mechanism.

14. The electric heating device according to claim 13, wherein said glass sphere holds a fluid expanding under an influence of heat and causing said glass sphere to burst upon exceeding the second over-temperature, and said switching element prestressed by said spring is triggered as a result of said glass sphere bursting.

15. The electric heating device according to claim 11, wherein said thermally-triggered isolating switch is disposed directly in a current path for supplying current to said heating element.

16. The electric heating device according to claim 11, wherein said air duct has an opening forming said recess, and a hat-shaped heat shield covers said opening.

17. The electric heating device according to claim 16, wherein at least one of said air duct or said hat-shaped heat shield is formed of sheet metal.

18. The electric heating device according to claim 11, wherein the air flow in the air duct flows in a flow direction being predetermined by said fan, and said recess is disposed upstream of said heating element in said flow direction.

19. The electric heating device according to claim 16, which further comprises:
a two-part housing having first and second independent housing units disposed adjacent one another;
said air duct being disposed in said first housing unit;
said first and second over-temperature switches being disposed in said second housing unit;
said opening being formed between said first housing unit and said second housing unit; and
said hat-shaped heat shield being disposed in said second housing unit.

20. The electric heating device according to claim 19, wherein said housing units are two respective non-flammable troughs disposed one above the other.

21. A fan heater for heating a sanitary room in a rail-borne vehicle, the fan heater comprising:
an electric heating device according to claim 11.
